(19) United States
(12) Patent Application Publication
(10) Pub. No.: US 2019/0035532 A1
(43) Pub. Date: Jan. 31, 2019

(54) Vertical Winding Assembly

(71) Applicant: SIEMENS AKTIENGESELLSCHAFT, München (DE)

(72) Inventors: TIM-FELIX MAI, WENDLINGEN (DE); RICHARD SILLE, KIRCHHEIM (DE); STEFFEN WEINERT, WANGEN (DE)

(21) Appl. No.: 16/069,992

(22) PCT Filed: Dec. 15, 2016
(86) PCT No.: PCT/EP2016/081125

§ 371 Date: Jul. 13, 2018

(30) Foreign Application Priority Data
Jan. 15, 2016 (DE) 10 2016 200 461.1

(51) Int. Cl. H01F 27/28; H01F 27/32; H01F 41/063; H01F 41/12

(52) U.S. Cl. CPC H01F 27/28; H01F 41/122; H01F 41/063; H01F 27/323

(57) ABSTRACT

A winding assembly has a plurality of winding sections that are arranged one above the other in an axial direction and that are electrically connected together to form a series circuit. Retaining devices retaining the winding sections at a distance from one another. The winding assembly which has a high dielectric strength and the disc windings are connected together with a small spacing. The retaining devices have at least one retaining element which extends into at least two mutually adjacent winding sections and the retaining element is rigidly connected to the winding sections into which the retaining element extends.

The invention relates to a winding assembly with a number of winding sections which are arranged one after the other in the axial direction, and which are electrically interconnected to constitute a series circuit, and retaining means for the maintenance of a mutual clearance between said winding sections.

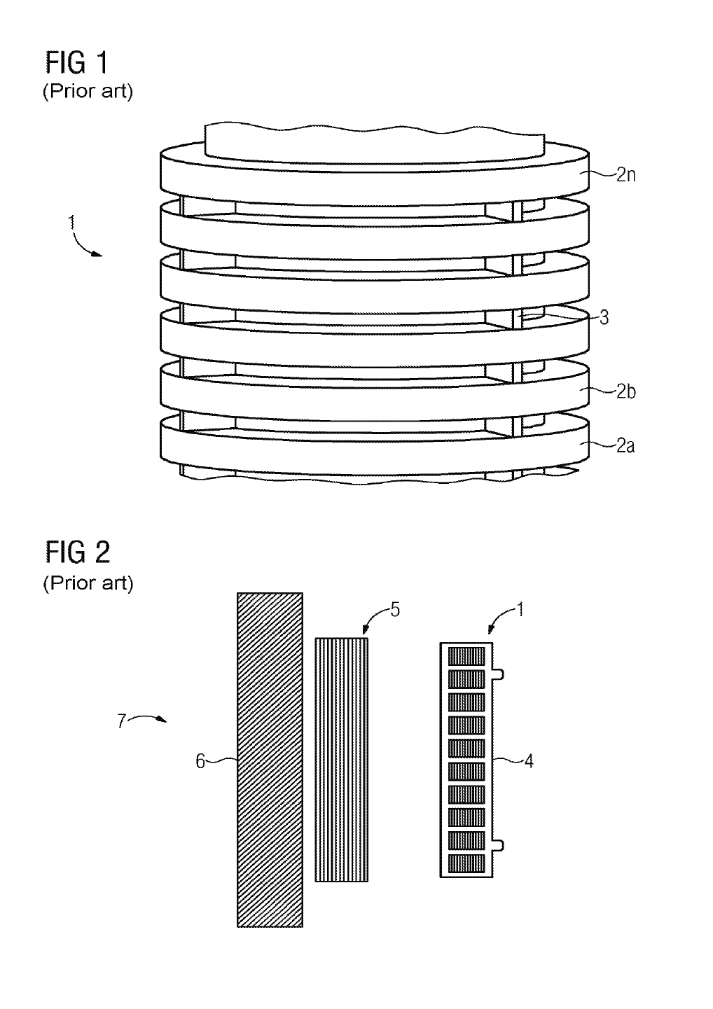

A winding assembly of this type is known from established practice. The attached FIG. 1 thus represents a winding assembly according to the prior art, before the latter has been enclosed in a cast resin or, in other words, embedded therein. It will be seen that the winding assembly 1 is comprised of winding sections 2a, 2b, . . . , 2n, stacked vertically one on top of another, wherein the winding sections 2a, 2b, . . . , 2n are electrically interconnected to constitute a series circuit. The winding sections 2a . . . 2n are comprised of mutually overwound winding layers, wherein each winding section 2a . . . 2n is expanded by the winding-on of winding layers in the radial direction. In practice, winding sections of this type are customarily described as disk windings 2a, . . . , 2n. In order to stack the disk windings 2a, . . . , 2n one on top of another with a specific clearance, which must be observed on the grounds of the requisite voltage withstand of the winding assembly, holding blocks 3 are provided, which are arranged between the disk windings 2a, . . . , 2n as retaining means. A block-type retaining means of this type is encumbered by a disadvantage, in that it bridges the insulation between the disk windings 2a, 2n over a substantial area. Moreover, any protruding insulating film which is wound into the winding sections as a conductor insulator is compressed flat. This also impairs the quality of the subsequent solid insulation.

FIG. 2 shows a schematic representation of the winding assembly 1 according to FIG. 1, wherein the latter is embedded in a solid winding insulator 4 comprised of a winding insulating material. The winding assembly 1 constitutes an HV-side winding, only the right-hand side of which is represented in cross-section. It can be seen that the HV-side winding encloses a LV-side winding 5, which in turn encloses one leg 6 of an iron core. The LV-side winding 5 and the constituent winding assembly 1 of the HV-side winding are elements of a transformer, which is represented schematically in FIG. 2 as the prior art.

The object of the invention is the disclosure of a winding assembly of the above-mentioned type, which has a high voltage withstand, and in which the winding sections are arranged with a small clearance in relation to each other.

This object is achieved according to the invention, in that the retaining means comprise at least one retaining element which extends into at least two adjacently arranged winding sections, said retaining element being rigidly connected to the winding sections into which it extends.

According to the invention, a retaining element is provided which extends into the winding sections and is surface-bonded to the latter. In the context of the invention, block-type retaining elements, which might bridge any subsequent insulation applied by casting between the winding sections, are avoided. Moreover, any flat compression of a film-type insulator is precluded. According to the invention, the retaining elements can be fitted during the winding of the winding sections between the mutually insulated electrical conductors of the winding layers. In this manner, the retaining elements extend between two mutually overlying winding layers, and can thus be surface-bonded to the latter.

Advantageously, each winding section is bonded to at least one retaining element. According to this advantageous further development, all the winding sections of the winding assembly are bonded together by means of retaining elements. In other words, the entire winding assembly is exclusively bonded together by means of the retaining elements according to the invention.

Advantageously, each retaining element is configured as a flat insert strip. A flat insert strip can easily be inserted between the winding layers during the winding of the winding sections.

The insert strip extends, for example, into only two adjacently-arranged winding sections. Alternatively, the insert strip can be configured with a sufficient length, such that it extends as a one-piece component through all the winding sections of the series-connected arrangement. A flat insert strip has the advantage that the latter has a large contact surface with the winding sections into which said insert strip extends.

Appropriately, each winding section comprises mutually overwound winding layers, wherein the winding layers are mutually insulated, and comprise an electrical conductor. The electrical conductor is, for example, a flat metal strip conductor, wherein insulating films are wound in between the metal conductors, in order to provide the requisite electrical insulation between the electrical conductors. Alternatively, an insulating lacquer can be applied to the electrical conductor.

According to an advantageous further development with respect hereto, each retaining element extends between mutually overwound winding layers, and is rigidly connected to at least one of said winding layers. Advantageously, each retaining element is rigidly connected to both of the winding layers between which it extends.

According to an appropriate further development with respect hereto, the retaining elements are arranged in pairs and extend between the winding sections with a mutual radial clearance. In other words, the two retaining elements in a pair extend adjacently in a radial direction to form a double attachment.

Appropriately, in the interests of the further stabilization of a winding section, winding layers are at least partially rigidly interconnected. The mutual connection of the winding layers is appropriately achieved by means of a cured resin. This resin can for example be introduced between the winding layers. The resin can also be applied in the form of a component of a prepreg, wherein the resin is present in the B-stage. At room temperature, the prepreg thus assumes adhesive properties, such that the winding layers are already mutually adhered upon the winding thereof. By means of the preheating of the entire winding assembly, the prepreg is cured, such that a stable bond is formed thereafter between the winding layers. This additional stabilization improves the mechanical strength of the winding assembly, and simplifies the subsequent casting of the series-connected arrangement in resin. The term “prepreg” is derived from English, and is an abbreviation for “pre-impregnated fibers”. The term “prepreg” is employed here to signify a fiber matrix, which is impregnated with a non-fully-cured resin.

Appropriately, each retaining element is constituted of a resin-impregnated, specifically an epoxy resin-impregnated glass-fiber fabric. In an advantageous further development with respect hereto, the coefficient of expansion of the retaining element is matched to the coefficient of expansion of the subsequent resin insulation for the entire winding assembly.

Appropriately, each retaining element is adhered to the winding sections into which it extends. Here again, the bonding of the retaining elements to the winding sections is achieved by means of an appropriately non-fully-cured prepreg. By the application of heat, the prepreg is cured, such that the bond between the retaining element and the respective winding sections is reinforced.

Appropriately, each winding section is configured as a disk-shaped disk winding. Disk windings are configured with a crown-shaped design. The winding layers in a disk winding extend exclusively in a common horizontal layer or ply. During winding, each winding layer of the disk winding expands exclusively in the axial direction.

The winding sections are, for example, constituted by a single conductor, which is continuously wound.

As already described above, it is appropriate that the winding sections are at least partially embedded in a winding insulator, which is comprised of a solid winding insulating material. A solid winding insulating material of this type which is most familiar to a person skilled in the art is, for example, an epoxy resin. A winding assembly of this type which is insulated by a solid body is also described as a cast resin winding.

According to a further configuration of the invention, at least one base element is provided, which is connected to one of the winding sections and is designed to carry the entire winding assembly. To this end, appropriately, each base element incorporates a base insulating section, which is formed of an electrically-insulating solid insulating material. The end region of the base element engages with a component, wherein the base insulating section provides the requisite electrical insulation. In service, the winding sections are at a high-voltage potential. The base element permits the upright casting of the series-connected winding sections, thus permitting the constitution of a heavy interior wall thickness of the solid winding insulator. In this manner, the winding assembly according to the invention can be exposed, with equivalent dimensioning, to higher voltage ratings.

The invention further relates to a method for producing a winding assembly, wherein winding sections are wound, the winding layers are comprised of mutually insulated electrical conductors, at least one retaining element is inserted between the winding layers during winding, such that it extends between at least two winding sections, the winding assembly is cast in an upright position with an insulating material, and is warmed for the curing of said insulating material.

Appropriately, the winding assembly is pre-heated further to the fitting of the retaining elements, such that it bonds each retaining element to the winding sections into which it extends. By the pre-heating of the winding assembly, not only can each retaining element be bonded to the respective winding sections but, in the advantageous variants of the invention, the bonding of a prepreg between winding layers of the disk windings can also be achieved.

Further appropriate configurations and advantages of the invention are the subject matter of the following description of exemplary embodiments of the invention, with reference to the figures in the drawing, in which the same reference symbols identify components of identical function, and in which:

FIG. 1 shows a winding assembly according to the prior art, prior to casting;

FIG. 2 shows a schematic sectional view of a cast resin transformer having a winding assembly according to FIG. 1, after casting;

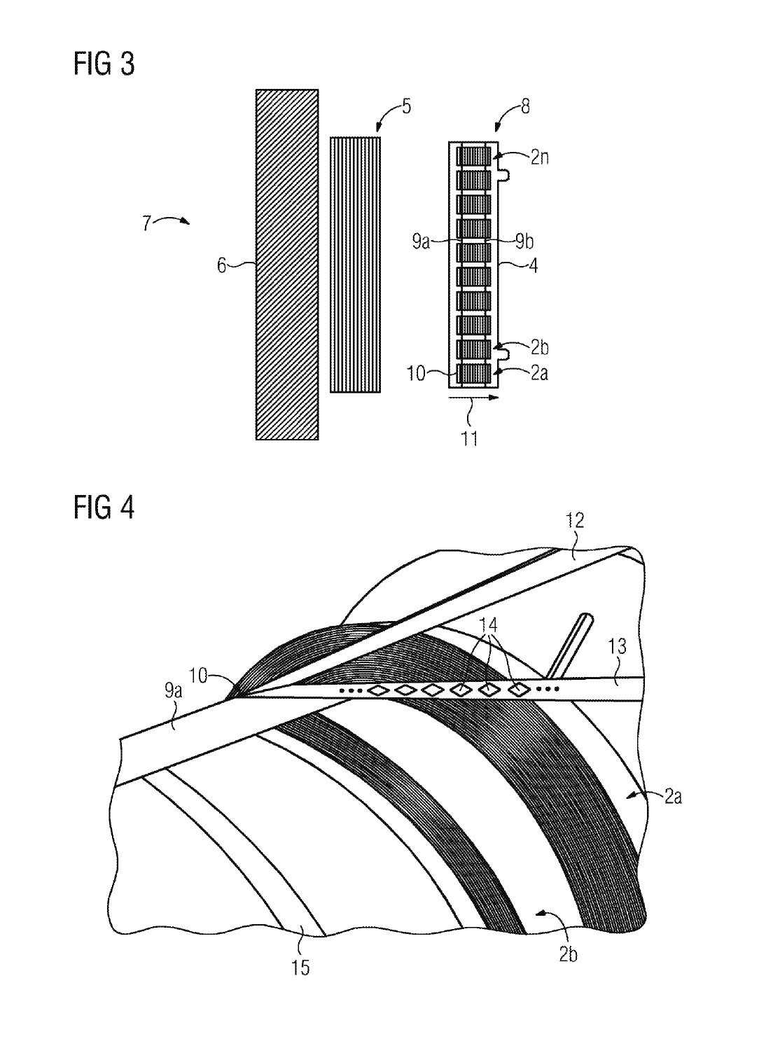

FIG. 3 shows an exemplary embodiment of the winding assembly according to the invention, after casting; and

FIG. 4 shows a schematic representation of an exemplary embodiment of the method according to the invention.

FIGS. 1 and 2 represent a winding assembly 1 according to the prior art, before and after casting respectively, and have already been described above.

FIG. 3, in a schematic representation of an exemplary embodiment, shows a sectional view of a transformer 7 according to the invention, showing one leg 6 of an iron core, a LV-side winding 5 and an exemplary embodiment of the winding assembly 8 according to the invention, which functions here as the HV-side winding. It can be seen that retaining means 9a and 9b extend between the disk windings 2a, 2b, 2n. The retaining means 9a and 9b are respectively configured as flat insert strips, and each extend in a one-piece arrangement through all the disk windings 2a, 2b, . . . , 2n of the winding assembly 8. Moreover, in FIG. 3, the winding layers 10 of any given winding section 2a, 2b, . . . , 2n can be seen. In the exemplary embodiment represented in FIG. 3, the winding layers 10 are wound from an inner side, which faces the leg 6, outwards in the radial direction 11. As the number of winding layers 10 increases, any given winding section 2a, . . . , 2n thus expands from the interior to the exterior. The retaining means 9a and 9b extend between the winding layers and are rigidly connected to the latter, such that a mutual clearance is maintained between the winding sections 2a, . . . , 2n by the retaining means 9a and 9b. For this reason, it is possible for the winding sections 2a, 2b, . . . , 2n to be cast in the liquid winding insulation material, in an unsecured arrangement with no winding carrier, wherein the winding insulation material is fully cured thereafter by heating. In this manner, a cost-effective winding assembly 8 is provided, wherein the winding insulator 4 can assume a freely-selectable internal wall thickness of between 1 mm and 50 mm. From FIG. 3, it can further be seen that the winding layers 10 extend within a horizontal layer in a crown-shaped pattern, such that the winding sections 2a, 2n constitute “disk windings”. The disk windings 2a, 2n are circumferentially enclosed such that, in the interior of any given disk winding, the leg 6 extends in combination with the LV-side winding 5.

FIG. 4 shows the incorporation by winding of a retaining element 9a in the winding sections 2a, 2n. It can be seen that a metallic strip conductor 12, for example of aluminum, is wound, together with an insulating film 13, onto a previously wound winding layer 10. The insert strip 9a is initially inserted by way of a retaining means. The insert strip 9a is comprised of a glass-fiber prepreg. The prepreg of the insert strip 9a is not fully cured. The retaining element 9a thus incorporated by winding, further to the incorporation by winding of the retaining element 9b in a subsequent winding layer, is pre-heated, such that a rigid connection is formed between the respective winding sections or disk windings 2a, 2n and the prepregs 9a, 9b. The winding carrier can then be removed, such that the retaining elements 9a, 9b maintain a mutual clearance between the disk windings 2a, 2n—in the absence of any winding insulation 4. Block-type spacers according to the prior art can be omitted.

From FIG. 4, it can further be seen that rhombus-shaped regions are configured on the insulating film 13. In these rhombus-shaped regions, the insulating film 13 is impregnated on both sides with a punctually-applied resin 14 in the “B-stage”, as a layer bonding agent. A resin of this type in the B-stage, which can also be applied in the form of a prepreg, shows adhesive properties. In the same way as the constituent prepreg of the retaining elements 20a and 20b, the resin of the layer bonding agent 14 is also cured on both sides, such that a mechanically secure bond is formed between the mutually overwound layers.

In this manner, a solid composite structure of the winding sections 2a, 2n is constituted, such that the winding carrier 15, specifically further to the pre-heating of the prepreg, can be removed, and the winding assembly can be cast in the liquid winding insulating material in an upright position. Further advantages can be achieved if the winding section 2a is equipped with base elements, which are not represented in the figure, upon which the winding sections 2a . . . 2n can be mounted in a stacked arrangement.

1-18. (canceled)

19. A winding assembly, comprising:
a plurality of winding sections disposed one above another in an axial direction, said winding sections being electrically interconnected to form a series circuit;
retaining devices disposed to maintain a spacing distance between said winding sections, said retaining devices including at least one retaining element that extends into at least two mutually adjacent winding sections, said retaining element being rigidly connected to said at least two winding sections into which said retaining element extends.

20. The winding assembly according to claim 19, wherein each said winding section is bonded to at least one retaining element.

21. The winding assembly according to claim 19, wherein said at least one retaining element is a flat insert strip.

22. The winding assembly according to claim 19, wherein each said winding section is comprised of winding layers formed by an electrical conductor wound onto one another and insulated from one another.

23. The winding assembly according to claim 22, wherein said retaining element extends between mutually over-wound winding layers and is rigidly connected to at least one of said winding layers.

24. The winding assembly according to claim 22, wherein said at least one retaining element is one of a plurality of retaining elements and said retaining elements are arranged in pairs and extend between said winding sections with radial clearance between one another.

25. The winding assembly according to claim 22, wherein said winding layers are at least partially rigidly interconnected.

26. The winding assembly according to claim 25, wherein said winding layers are rigidly interconnected by a cured resin.

27. The winding assembly according to claim 19, wherein said at least one retaining element is a prepreg.

28. The winding assembly according to claim 27, wherein said prepreg is formed of glass-fiber fabric.

29. The winding assembly according to claim 19, wherein said retaining element is adhered to the respective said winding section into which said retaining element extends.

30. The winding assembly according to claim 19, wherein each winding section is a disk-shaped disk winding.

31. The winding assembly according to claim 19, which comprises a winding insulator formed of a solid winding insulation material and disposed to at least partially enclose said winding sections.

32. The winding assembly according to claim 19, which comprises at least one base element connected to one of said winding sections and configured to carry the winding assembly in an entirety.

33. The winding assembly according to claim 32, wherein each said base element incorporates a base insulating section, which is formed of an electrically-insulating solid base insulating material.

34. The winding assembly according to claim 33, wherein said base insulating material is embedded in a winding insulator, which is formed of a solid winding insulating material.

35. A method of producing a winding assembly, the method comprising:
forming winding sections by winding layers composed of electrical conductors that are insulated from one another;
inserting at least one retaining element between the winding layers during winding, with the at least one retaining element extending between at least two winding sections;
casting the winding assembly in an insulating material while in an upright position; and
heating the insulating material for curing the insulating material.

36. The method according to claim 35, which comprises preheating the winding assembly subsequent to the step of inserting the retaining elements, for bonding each of the retaining elements to the winding section into which the respective retaining element extends.
